(19) United States
(12) Patent Application Publication
(10) Pub. No.: US 2015/0206195 A1
(43) Pub. Date: Jul. 23, 2015

(54) AUCTION MECHANISM WITH DECOUPLED SELECTION AND RANKING

(71) Applicant: Microsoft Corporation, Redmond, WA (US)

(72) Inventors: Nikhil Devanur Rangarajan, Redmond, WA (US); Balasubramanian Sivan, Bellevue, WA (US); Denis Charles, Bellevue, WA (US)

(73) Assignee: Microsoft Corporation, Redmond, WA (US)

(21) Appl. No.: 14/157,784

(22) Filed: Jan. 17, 2014

(51) Int. Cl. G06Q 30/02

(52) U.S. Cl. CPC G06Q 30/0275; G06Q 30/0269

(57) ABSTRACT

An auction mechanism that decouples advertisement selection from advertisement ranking is described herein. A page to be displayed on a client computing device has a plurality of advertisement positions. Responsive to receipt of data that is indicative of content to be included on the page, a plurality of bids corresponding to a respective plurality of advertisements are received, wherein each bid has a respective bid value. Further, a respective quality score is computed for each advertisement responsive to the receipt of the data. A subset of advertisements are selected from the plurality of advertisements based upon their respective bid values. Subsequently, the selected advertisements are ranked and assigned to the advertisement positions based upon their quality scores, which are independent of their bid values.

### BACKGROUND

Revenue generated based upon presentment of advertisements on a display screen in conjunction with other content (e.g., search results) is currently on the order of billions of dollars. In an exemplary scenario, an advertisement server is provided with data that is indicative of content that is to be displayed on a display screen of a computing device. Such data can be, for instance, a query (or portion of a query) submitted to a search engine by a user, wherein the user is attempting to acquire information that is related to the query.

Responsive to receiving the query, the ad server conducts an auction for advertising positions on a search results page, where a plurality of computer-executable agents (programmed to act in accordance with respective wishes of advertisers) submit bids having respective bid values to win the auction, and thus have an advertisement corresponding to a bid displayed to the user in one of the advertising positions. Generally, the ad server conducts the auction such that revenue of the ad server is maximized. With more specificity, for each auction participant (advertisement), the advertising server computes a respective auction value, wherein an auction value is a product of a respective bid value (corresponding to the advertisement) and quality score for the advertisement. Winners of the auction are selected and ranked based upon their respective computed auction values. For example, with respect to a search results page that comprises five advertisement positions, the five advertisements having the five highest auction values from amongst all computed auctions values are selected, and the five advertisements are respectively assigned to the advertisement locations based upon their auction values. That is, the advertisement having the highest auction value is assigned to an uppermost (most desirable) advertisement position, the advertisement having the second highest auction value is assigned to a next uppermost advertisement position, and so forth.

Typically, advertisers displayed in the advertisement positions are charged only if the end-user selects their respective advertisements. For keyword auctions, where the advertisements are shown in the search results page, the generalized second price (GSP) auction has been employed to determine an amount of money to charge an advertiser whose advertisement was selected by the end-user. Conventionally, the advertiser pays an amount that is a function of the auction score for the immediately lower advertisement in the ranked advertisements. Another exemplary auction mechanism that has been employed to determine the amount of money to charge the advertiser when the end user clicks the advertisement is the Vickrey-Clarke-Groves (VCG) auction, where the advertiser pays an amount that is based upon the results of the auction if the advertiser had not submitted a bid (e.g., the auction is simulated without the advertiser having participated and the advertiser is charged based upon results of the simulated auction).

### SUMMARY

The following is a brief summary of subject matter that is described in greater detail herein. This summary is not intended to be limiting as to the scope of the claims.

Described herein are various technologies pertaining to decoupling the selection of advertisements to display on a display medium (e.g., a page) with the ranking of the advertisements (and thus, positioning of the advertisements) for display on the display medium. In an exemplary embodiment, a client computing device may have a client application executing thereon, such as a web browser, a client-side social networking application, etc., wherein a user of the client computing device retrieves content by way of the client application. More specifically, the client application can be directed towards a content server that is executing a content application, such as a search engine, a social networking application, etc. In a non-limiting example, the user of the client computing device can transmit a query by way of the client application to a search engine that is executing on the content server.

The content server can transmit data that is indicative of content that is to be included in a display medium that is to displayed on a display associated with a client computing device to an ad server, wherein the data transmitted to the ad server can be a query submitted by the user, a keyword in the query, a portion of a newsfeed generated by way of a social networking application, etc. The ad server, responsive to receiving such data, can execute an auction for a plurality of advertisement positions on the display medium, where a plurality of advertisers, through utilization of a respective plurality of computer-executable agents, can participate in the auction to cause their respective advertisements to be displayed on the display medium at the client computing device. Accordingly, based on the content that is to be displayed, the computer-executable agents can submit respective bids having respective bid values, each bid corresponding to a respective advertisement, wherein the higher the bid value, the more the advertiser is willing to pay when its advertisement is selected (clicked) by the end-user. The advertisements that are potentially displayed can have quality scores respectively assigned thereto, wherein the quality scores, for example, can be based upon the content that is to be included in the display medium (e.g., a quality score may be higher when content of a respective advertisement is highly related to the content that is to be included in the page). Generally, a quality score for an advertisement can capture the relevance of the advertisement to the content, the content and appeal of the advertisement to an end-user, and other related factors. Further, in an example, a quality score for an advertisement may be based upon a computed probability that the end-user that is employing the client computing device will interact with (e.g., click) the advertisement when presented to the end-user.

Responsive to receiving 1) the bid values of the respective bids from the computer-executable agents; and 2) the quality scores for the respective advertisements for which bids have been submitted, the ad server can filter advertisements from participating in the auction based upon the bid values and quality scores. For instance, the ad server can compare each bid value with a reserve bid value, and can prevent advertisements from participating in the auction whose respective bid values are below the reserve bid value. Similarly, to ensure that overall quality of the display medium (in its entirety) provided to the end-user is relatively high, the ad server can prevent advertisements from participating in the auction whose respective quality scores are below a quality threshold. The advertisements that participate in the auction, then, have respective bid values corresponding thereto above the reserve bid value and respective quality scores above the quality threshold.

Thereafter, the ad server can select advertisements for inclusion in the display medium based upon the bid values (e.g., and without regard to the quality scores). Thus, for instance, when the display medium has five advertisement positions that are the subject of the auction, the ad server can select the advertisements for inclusion that have the five highest bid values from amongst all bid values. Subsequent to the five advertisements being selected for inclusion on the display medium, the advertisements can be ranked based upon their respective quality scores (e.g., and without regard to their respective bid values). Thus, for example, of the five advertisements selected for display in the five advertisement positions, the advertisement with the highest quality score of the five advertisements can ranked highest, the advertisement with the second highest quality score of the five advertisements can be ranked second highest, and so forth.

Subsequent to the selected advertisements being ranked based upon their respective quality scores, the selected advertisements can be assigned to respective advertisement positions on the display medium based upon the ranking Thus, the most highly ranked advertisement is assigned to the uppermost (e.g., most desirable) advertisement position, the second most highly ranked advertisement is assigned the second most desirable advertisement position, and so on. The page rendered at the client computing device has the advertisements in their appropriate advertisement positions. When an advertisement (regardless of its position) is selected on the rendered display medium, the ad server can receive an indication of such selection and can charge the respective advertiser a fee based upon a highest non-winning bid value or the reserve bid value, whichever is highest. Continuing with the example set forth above, when an advertisement on the display medium is clicked, the advertiser owning the clicked advertisement can be charged an amount that is based upon the sixth highest bid value (the highest non-winning bid value) or a reserve value, whichever is highest.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary system that facilitates decoupling the selection of advertisements from the ranking of advertisements when performing an auction for advertisement positions on a page.

FIG. 2 illustrates a data store comprising advertisement data.

FIG. 3 illustrates an exemplary advertisement server.

FIG. 4 is a graphical depiction of the selection and ranking of advertisements that participate in an auction for advertisement positions.

FIG. 5 is a flow diagram illustrating an exemplary methodology for performing an auction for advertisement positions.

FIG. 6 is a flow diagram illustrating an exemplary methodology for performing an auction for advertisement positions.

FIG. 7 is an exemplary computing system.

### DETAILED DESCRIPTION

Various technologies pertaining to auctions for advertisement positions, such as keyword auctions, are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by a single system component may be performed by multiple components. Similarly, for instance, a single component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

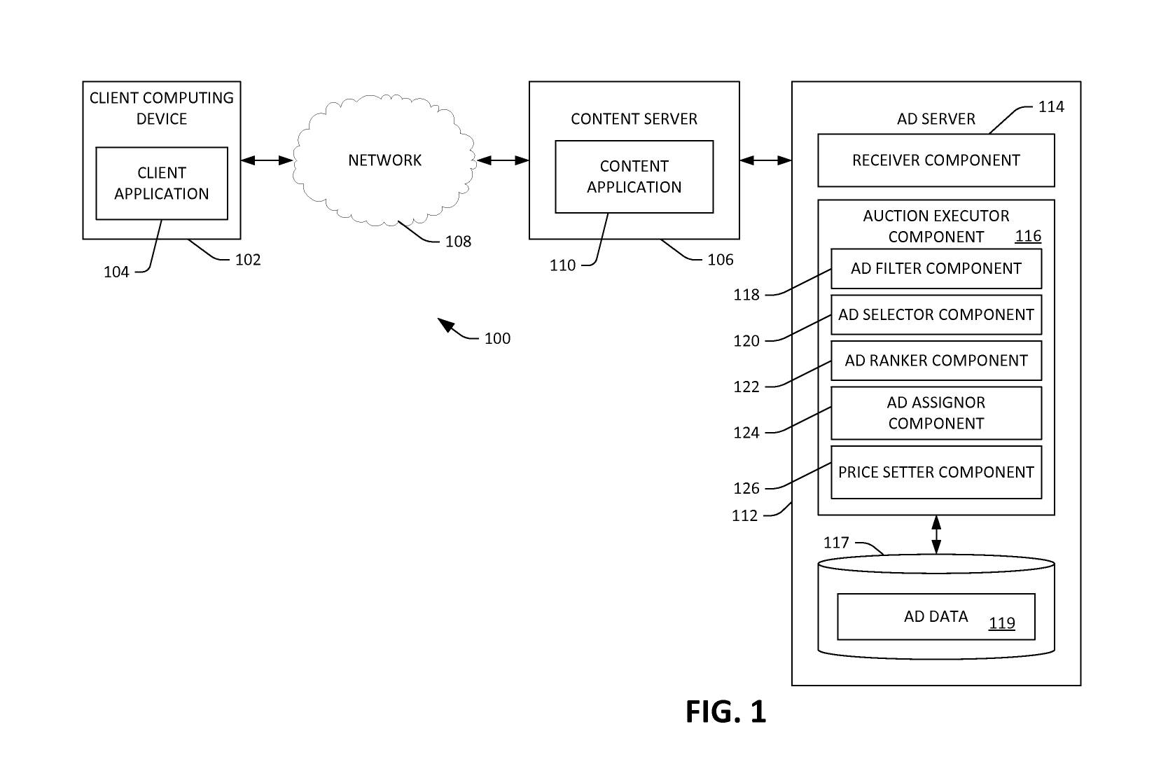

With reference now to FIG. 1, an exemplary system 100 that facilitates selection and ranking of advertisements to display in respective advertisement positions on a display medium is illustrated. The system 100 includes a client computing device 102 with a client application 104 installed and executing thereon. The client computing device 102 may be any suitable computing device that has a display associated therewith, such that the client computing device can be, but is not limited to being, a desktop computing device, a laptop computing device, a convertible computing device, a tablet (slate) computing device, a mobile telephone, a phablet, a computing device in an automobile, etc. The display associated with the client computing device 102 can be a display screen, a projected display (e.g., a “heads-up” display in an automobile, etc.). The client application 104 can be an application that is configured to present graphical content to an end-user by way of the display screen of the client computing device 102. In an example, the client application 104 can be a web browser that is configured to retrieve content from web servers. In another example, the client application 104 may be a client-side social networking application, such as an application that is configured to retrieve and present a newsfeed on the display of the client computing device 102. In another example, the client application 104 may be a video game that executes primarily on the client computing device 102, but that is advertisement-supported. In such an example, advertisements can be selectively displayed during play of the video game (e.g., presented as banner ads on the display screen, through product placement during game play, etc.).

The exemplary system 100 further comprises a content server 106 that can be in communication with the client computing device 102 by way of a network 108, such as the Internet. The content server 106 includes a content application 110 that is configured to provide a display medium for display on the display screen of the client computing device 102, wherein the display medium includes content. In an exemplary embodiment, the display medium can be a page, such as a web page or a page rendered by another application, a frame of a video game, a frame of a video, etc. Additionally, the display medium includes a plurality of advertisement positions that can be populated by respective advertisements. In an exemplary embodiment, the content application 110 can be a search engine that receives a query by way of the client application 104 executing on the client computing device 102, wherein the search engine is configured to provide a search results page to the client application 104. Thus, the client application 104 may be a web browser that is directed to a uniform resource locator (URL) of the search engine (the content application 110), wherein an end-user submits the query to the search engine by way of the web browser executing on the client computing device 102. In another example, the client application 104 may be a dedicated search application that is configured to transmit a user-entered query to the content application 110. In still yet another example, the content application 110 may be a server-side social networking application that is configured to provide, for instance, a page that includes a news feed to the client-side social networking application for display on the display screen of the client computing device 102.

The system 100 additionally comprises an ad server 112 that is in communication with the content server 106. Additionally or alternatively, while not shown, the ad server 112 may also be directly in communication with the client computing device 102. The display medium provided by the content application 110 for display on the display of the client computing device 102, as noted above, includes a plurality of advertisement positions. Generally, as will be described in greater detail herein, the ad server 112 is configured to select and rank advertisements for inclusion in the advertisement positions on the display medium presented on the display of the client computing device 102, wherein the selection of the advertisements for inclusion in the advertisement positions on the display medium is decoupled from the ranking of the advertisements (and thus assignment of advertisements to the respective advertisement positions).

With more particularity, the ad server 112 includes a receiver component 114 that receives data that is indicative of content that is to be displayed on the display medium, wherein the display medium is to be displayed on a display of the client computing device 102. In an example, the data received by the receiver component 114 can be a query submitted to a search engine by the user of the client computing device 102, a keyword in the query, text in a post in a newsfeed to be presented on the display of the client computing device 102, or other suitable data pertaining to content that is to be presented on the display medium.

The ad server 112 additionally includes an auction executor component 116 that is configured to conduct an auction for the advertisement positions on the display medium that is to be displayed on the display of the client computing device 102. Generally, in auctions for advertisement positions, advertisers set forth respective computer-executable agents that are programmed to submit respective bids with respective values based upon the data received by the receiver component 114, wherein each bid corresponds to a respective advertisement. For purposes of explanation, reference is made to advertisements participating in the auction, where each advertisement has a respective first score and a respective second score assigned thereto. Thus, responsive to the receiver component 114 receiving the data that is indicative of the content that is to be displayed on the display medium, the auction executor component 116 receives, for each advertisement in a plurality of advertisements that wish to participate in the auction, a respective first score and a respective second score. Accordingly, the ad server 112 can include a data store 117 that comprises ad data 119, where the ad data 119 comprises identities of advertisements that wish to participate in the auction for the advertisement positions, respective first scores for the advertisements, and respective second scores for the advertisements.

Pursuant to an example, a first score for each advertisement can be or be based upon a bid value for a respective advertisement. A second score for each advertisement can be a quality score that is indicative of a quality of a respective advertisement, wherein the quality score captures relevance of the respective advertisement to the content included in the display medium, content of the respective advertisement, general appeal of the respective advertisement (e.g., as assigned by a manual reviewer of the respective advertisement), and related factors. For example, the second score for an advertisement can be based upon a computed probability that the user of the client computing device 102 will click or otherwise interact with the advertisement when the advertisement displayed on the display medium (in conjunction with the content) on the client computing device 102. In an exemplary embodiment, a respective first score and a respective second score, for each advertisement, may be independent of one another, such that the first score is not based upon the second score and the second score is not based upon the first score.

The auction executor component 116 can comprise an ad filter component 118 that can filter advertisements from participating in the auction for the advertisement positions on the display medium based upon their respective first scores and their respective second scores. More specifically, prior to the auction executor component 116 selecting and ranking advertisements, the ad filter component 118 can prevent advertisements from participating in the auction when their respective first scores are below a first threshold or their respective second scores are below a second threshold. That is, for each advertisement for which a respective bid has been submitted, the ad filter component 118 can compare a respective first score for an advertisement with a first threshold, and can prevent the advertisement from participating in the auction when the first score is below the first threshold (e.g., when the bid value for the advertisement is below a reserve bid value). Similarly, the ad filter component 118 can compare the respective second score for the advertisement with a second threshold, and can prevent the advertisement from participating in the auction when the second score for the advertisement is below the second threshold (e.g., when the quality score for the advertisement is below a predefined quality reserve). Advertisements not filtered by the ad filter component 118 (e.g., advertisements that qualify to participate in the auction) thus can have respective bid values that are equal to or above the reserve bid value and respective quality scores that are equal to or above the quality score threshold.

The auction executor component 116 further includes an ad selector component 120 that can select advertisements for inclusion in the advertisement positions on the display medium based upon the respective first scores of the advertisements (e.g., and without regard to the respective second scores of the advertisements). Accordingly, the number of advertisements selected by the ad selector component 120 can be equivalent to the number of advertisement positions on the display medium that is to be displayed on the display of the client computing device 102. When the first score for an advertisement represents a bid value of the advertisement, the ad selector component 120 can select advertisements having highest bid values for display on the display medium in the advertisement positions. More specifically, when the display medium has five advertisement positions thereon, the ad selector component 120 can select the five advertisements participating in the auction that have the five highest respective bid values.

The auction executor component 116 additionally includes an ad ranker component 122 that can rank the advertisements selected by the ad selector component 122 (the selected advertisements) based upon the respective second scores of the selected advertisements (e.g., and optionally without regard to the first scores of the selected advertisements). For example, when the second score for an advertisement is indicative of the quality of the advertisement (e.g., a quality score), the ad ranker component 122 can rank the selected advertisements based upon the respective quality scores of the advertisements. Therefore, an advertisement in the selected advertisements having the highest quality score will be ranked highest in a resultant ranking, an advertisement in the selected advertisements having a second highest quality score will be ranked second in the ranking, and so forth (e.g., without regard to their bid values). In contrast to conventional approaches, the ranking of the advertisements is decoupled from the selection of the advertisements to be displayed on the display medium.

The auction executor component 116 further includes an ad assignor component 124 that assigns the selected advertisements to respective advertisement positions on the display medium based upon the ranking of the selected advertisements undertaken by the ad ranker component 122. Accordingly, the ad assignor component 124 can assign the highest ranking advertisement in the ranking output by the ad ranker component 122 to the most desirable (e.g., uppermost) position on the display medium that is to be presented to the end-user on the display of the client computing device 102. Similarly, the ad assignor component 124 can assign the second most highly ranked advertisement in the ranking output by the ad ranker component 122 to the second most desirable (e.g., second highest) advertisement position on the display medium. Therefore, the ad assignor component 124 assigns each ad selected by the ad selector component 120 to a respective advertisement position on the display medium that is to be displayed on the display of the client computing device 102 based upon its respective rank in the ranking output by the ad ranker component 122.

Still further, the auction executor component 116 can include a price setter component 126 that sets a price to be charged to winners of the auction (e.g., the ads assigned to the advertisement positions on the display medium). In an exemplary embodiment, the price can be charged to an advertiser that owns an advertisement responsive to the advertisement being selected. In another example, the price can be charged on a per-impression basis. Further, the price setter component 126 can set the price(s) to be charged to the winners of the auction based upon a score assigned to at least one advertisement in the plurality of advertisements or a reserve price. In an example, the price setter component 126 can set the price(s) to be charged to the winners of the auction based upon respective first scores of the winners of the auction. In yet another example, the price setter component 126 can set the price(s) to be charged to the winners of the auction based upon respective first scores of the winners of the auction, respective second scores of the winners of the auction, and position(s) on the display medium of the advertisements.

The system 100 differs in a variety of manners from conventional approaches for conducting auctions for advertisement positions. First, conventionally, selection and ranking of advertisements is performed based upon a single score: the product of a respective bid value and a respective quality score. A problem with this conventional approach, however, is that an advertiser can submit a very high bid value to ensure that its advertisement is presented most prominently on a page. While this may maximize revenue of the ad server in the short-term, over time revenue may be negatively impacted, as end-users may be dissatisfied with being provided with less relevant or low-quality advertisements in prominent advertisement positions.

Furthermore, a charging scheme corresponding to the system 100 differs from that used in conventional auctions for advertisement positions. For instance, as the ad server 112 is configured to rank advertisements based upon their respective quality scores (e.g., without regard to their bid values), conventional pricing schemes in GSP and VCG auctions are not well-suited for use with the ad server 112. In the approach set forth herein, the advertisements selected for display on the display medium can have the same cost-per-click charge assigned thereto, wherein the cost-per-click charge is based upon a bid value set forth by a non-winning advertisement (e.g., the highest non-winning bid value). For example, when there are K advertisement positions on the page, the ad selector component 120 selects the K advertisements participating in the auction that have submitted the K highest bid values. In this example, each of the K advertisements is assigned a price-per-click charge that is based upon (e.g., equivalent to) the K+1 highest bid value submitted by one of the advertisements participating in the auction. Therefore, when the end user selects any of the advertisements displayed on the page, its respective advertiser is charged a fee based upon the K+1 highest bid value. Additionally or alternatively, the fee can be a reserve fee (when the reserve fee is above the K+1 highest bid value). Again, this is distinguishable from conventional charging approaches, where a click on an advertisement results in the advertiser paying a price based upon the next immediate highest bid (e.g., each displayed advertisement has its own respective cost-per-click).

While the examples set forth herein have described the advertisements being selected based upon bid values and subsequently ranked based upon quality scores, it is to be understood that the ad executor component 116 may alternatively select advertisements based upon their respective quality scores and subsequently rank the advertisements based on their respective bid values. Moreover, in some instances, it may be desirable to inject an advertisement into a set of advertisements to assist in computing a quality score. For example, an advertiser may set forth a new advertisement and it may be unknown as to how users will respond to such advertisement. To that end, the auction executor component 116 can assign a randomized value as the quality score, wherein the range of randomization can decrease over time as more users are presented with the advertisement and thus have the opportunity to interact with the advertisement.

Additionally, it is contemplated that in some instances, identical bid values may be submitted for ad positions (e.g. seven advertisements for five advertisement positions may have identical bid values). A variety of approaches can be employed by the auction executor component 116 to break ties. For example, ties can be broken based upon quality scores assigned to the advertisements, such that an advertisement with a highest quality score from amongst advertisements having equivalent bid values is selected. In another example, ties can be broken by way of random selection of one or more advertisements that have submitted equivalent bid values. In still yet another example, the auction executor component 116 can track which advertisements have been subjected to ties and can cycle through advertisements in some objective manner.

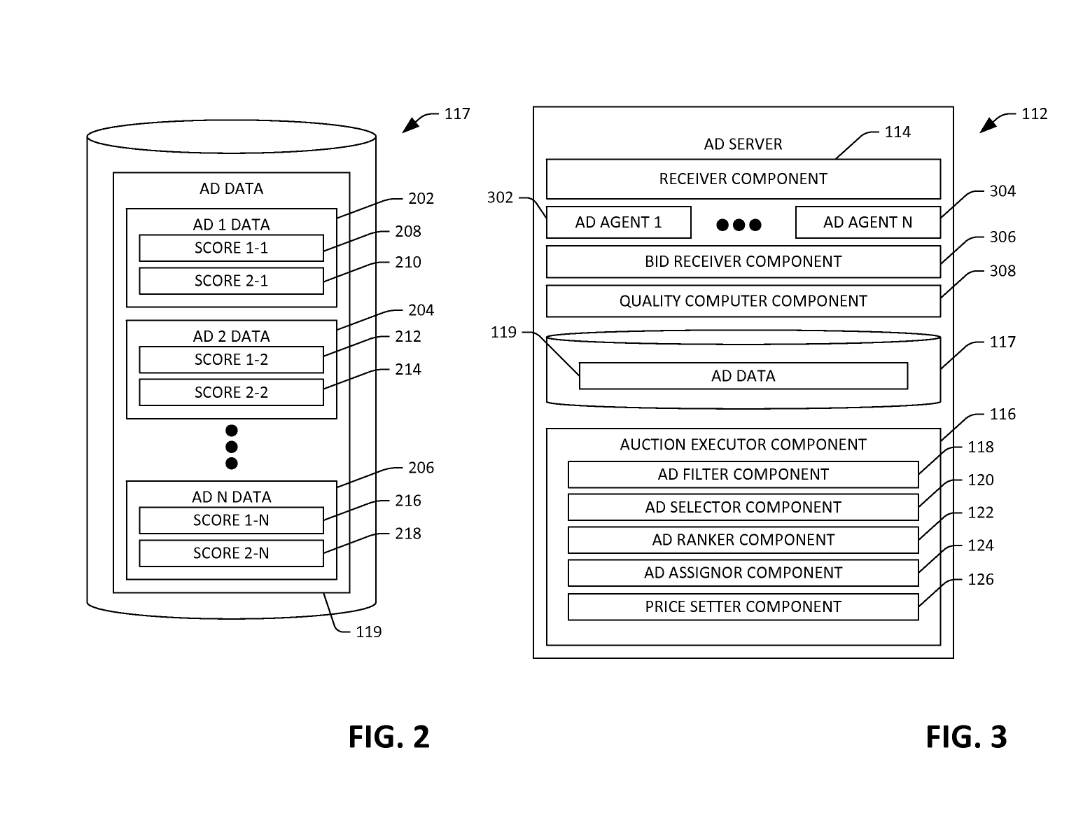

Referring now to FIG. 2, the data store 117 that is accessible to the auction executor component 116 is presented. The data store 117 comprises the ad data 119. The ad data 119 comprises data corresponding to each advertisement for which a bid has been submitted for an advertisement position on the display medium to be displayed on the display of the client computing device 102. Accordingly, the ad data 119 includes first ad data 202 for a first advertisement that has submitted a bid, second ad data 204 for a second advertisement that has submitted a bid, through Nth ad data 206 for an Nth advertisement that has submitted a bid. The first ad data 202 comprises a first score 208 (e.g., a bid value for the first advertisement) and a second score 210 (e.g., a quality score for the first advertisement). Similarly, the second ad data at 204 comprises a first score 212 for the second advertisement and a second score 214 for the second advertisement. Likewise, the Nth ad dated 206 comprises a first score 216 for the Nth advertisement and a second score 218 for the Nth advertisement. As noted above, the auction executor component 116 selects the advertisements for display on the display medium based upon their respective first scores 208, 212, and 216, and subsequently ranks selected advertisements based upon their respective second scores 210, 214, and 218.

Now referring to FIG. 3, an exemplary depiction of the ad server 112 is shown. As indicated above, the ad server 112 comprises the receiver component 114 that receives data that indicates that certain content is to be displayed on a display medium that is to be presented on a display of a client computing device. Responsive to the receiver component 114 receiving such data, a plurality of ad agents 302-304 can be notified that an auction is to be conducted based upon the data received by the receiver component 114. For example, the ad agents 302-304 may be programmed to submit bids having respective bid values when certain data (e.g., keywords) is received by the receiver component 114. In another example, the receiver component 114 can inform the ad agents 302-304 that a particular end-user is accessing a page (e.g., an advertiser may wish to advertise to a particular end-user), may inform the ad agents 302-304 that the end-user has demographics of interest to the ad agents 302-304, etc.

The ad agents 302-304 respectively correspond to particular advertisements, and are programmed to set forth bids having respective bid values to participate in an auction for advertisement positions on the page. In another exemplary embodiment, advertisers can pre-set bids having respective bid values, such that (for at least some advertisements) no ad agent is needed. A bid receiver component 306 is configured to receive bids set forth by the respective ad agents 302-304. The ad server 112 can additionally include a quality computer component 308 that computes a respective quality score for each advertisement corresponding to the ad agents 302-304. For example, the quality computer component 308 can compute a quality score for an advertisement based upon the content that is to be displayed on the page, the content of the advertisement, a manually generated indication of quality of the advertisement, user feedback pertaining to the advertisement, etc.

The data store 117 retains the bid values for the advertisements and the quality scores for the advertisements as the ad data 119. Responsive to the ad data 119 being constructed and stored in the data store 117, the auction executor component 116 can initiate an auction for the advertisement positions in the display medium. Initially, the ad filter component 118 can analyze the ad data 119 and prevent advertisements from being participants in the auction that have respective bid values beneath a predefined reserve bid value (e.g., a reserve bid value) or respective quality scores beneath a quality threshold. While the ad filter component 118 has been described as analyzing the ad data 119 subsequent to the bid values and quality scores both being received, it is to be understood that the ad filter component 118 can perform some of the above-described filtering actions immediately responsive to the ad agents 302-304 submitting bids (e.g., and prior to the quality computer component 308 computing quality scores for advertisements) or immediately responsive to the quality computer component 308 computing quality scores for advertisements (e.g., and prior to the ad agents 302-304 submitting bids).

The ad selector component 120, the ad ranker component 122, the ad assignor component 124, and the price setter component 126 then act as described above. Particularly, the ad selector component 120 selects a plurality of advertisements for presentment on the display medium based upon the respective bid values for the advertisements, wherein a number of selected advertisements is equivalent to a number of advertisement positions on the display medium. The ad ranker component 122 then ranks the selected advertisements based upon their respective quality scores (e.g., without regard to the respective bid values for the selected advertisements). The ad assignor component 124 then assigns advertisements in the selected advertisements to respective positions in the advertisement positions on the display medium based upon the ranking of the advertisements output by the ad ranker component 122. The price setter component 126 sets prices for the winners of the auction (the advertisements displayed on the page). In an example, when any of the advertisements presented on the display medium is selected (e.g., clicked) by the user of the client computing device 102, the advertiser is charged based upon the bid value set forth by the highest non-winning bidder or the reserve bid value, whichever is highest.

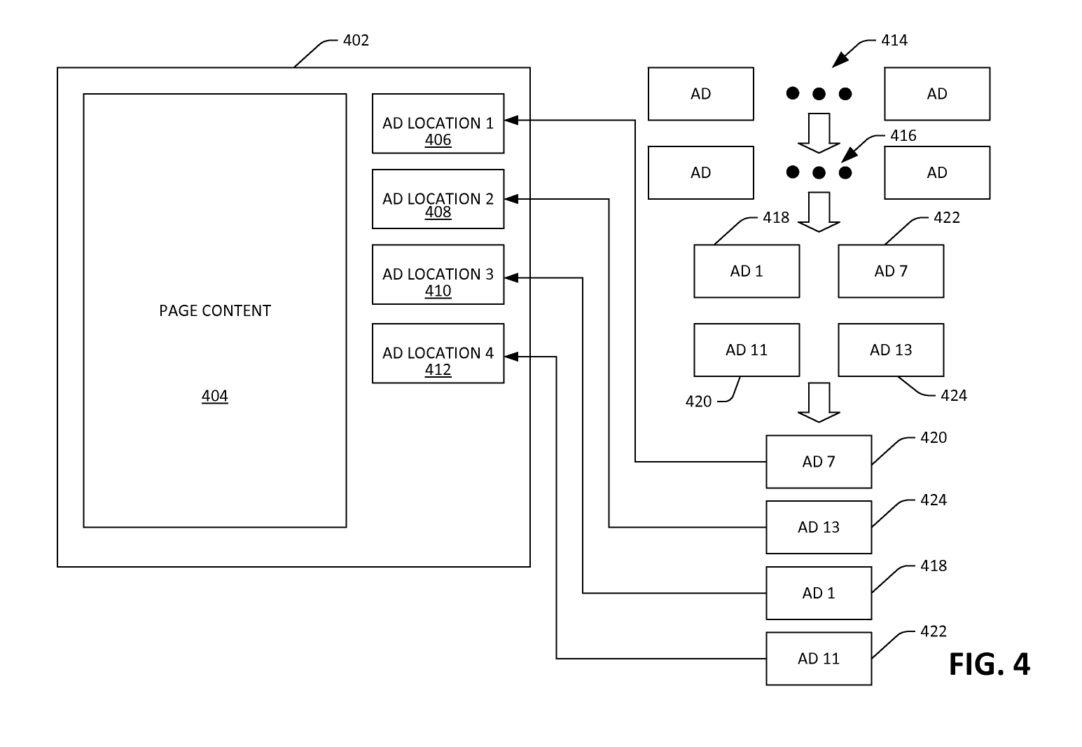

Now referring to FIG. 4, an exemplary graphical depiction 400 of an auction for advertisement positions on a page that is performed by the auction executor component 116 is illustrated. In the example shown here, the user of the client computing device 102 has requested a page 402 for presentment on the display of the client computing device 102. The page 402 can include particular page content 404, wherein the page content 404 can include search results based upon a search query set forth by the user of the client computing device 102, a newsfeed, etc. The page 402 additionally includes a plurality of ad positions 406-412 arranged vertically in a side-bar on the right-hand side of the page 402. In another example, the ad positions 406-412 may be arranged horizontally near the top of the page 402, arranged vertically on a left-hand side of the page, arranged vertically near the middle of the page 402, etc. Regardless of the arrangement of the ad positions 406-412, it is to be understood that certain ad positions are more desirable to advertisers than others. For instance, in the vertical arrangement shown in FIG. 4, the first ad position 406 can be the most desirable ad position from amongst the ad positions 406-412, while the fourth ad position 412 can be the least desirable ad position from amongst the ad positions 406-412.

The ad server 112 receives data that is indicative of the page content 404, and the auction executor component 116 conducts an auction for the advertisement positions 406-412. Initially, a first plurality of advertisements (collectively shown as advertisements 414) desirably participates in an auction for the ad positions 406-412, and thus bids are submitted for the respective advertisements 414. The ad filter component 118 prevents advertisements that have a bid value or a quality score below respective predefined thresholds from participating in the auction. This results in a second plurality of advertisements (collectively shown as advertisements 416) participating in the auction, where the second plurality of advertisements 416 is a subset of the first plurality of advertisements 414.

As there are four advertisement positions (e.g., ad positions 406-412) on the page 402, the ad selector component 120 selects four advertisements 418-424 that have the four highest respective bid values from amongst the bid values respectively set forth for the second plurality of advertisements 416. In the example shown in FIG. 4, a first advertisement 418 has set forth a highest bid value from amongst the bid values respectively set forth by the second plurality of advertisements 416, an eleventh advertisement 420 has set forth a second highest bid value from amongst the bid values respectively set forth by the second plurality of advertisements, a seventh advertisement 422 has set forth a third highest bid value from amongst the bid values respectively set forth by the second plurality of advertisements, and a thirteenth advertisement 424 has set forth a fourth highest bid value from amongst the bid values respectively set forth by the second plurality of advertisements 416. The ad selector component 120 has selected the advertisements 418-424 for presentment on the page 402.

The ad ranker component 122 then ranks the advertisements 418-424 based upon their respective quality scores. As shown in FIG. 4, the seventh advertisement 420 has a highest quality score from amongst the respective quality scores of the advertisements 418-424, the thirteenth advertisement 424 has the second highest quality score from amongst the respective quality scores of the advertisements 418-424, the first advertisement 418 has the third highest quality score from amongst the respective quality scores of the advertisements 418-424, and the eleventh advertisement has the fourth highest quality score from amongst the respective quality scores of the advertisements 418-424. The ad assignor component 124 then assigns the advertisements 418-424 to the advertisement positions 406-412 based upon the ranking of the advertisements 418-424 output by the ad ranker component 122. Specifically, as the seventh advertisement 420 is the most highly ranked advertisement in the ranking output by the ad ranker component 122, the ad assignor component 120 assigns the seventh advertisement 420 to the first ad position 406 (the most desirable ad position). Likewise, the ad assignor component 120 assigns the thirteenth advertisement 424 to the second ad position 408, assigns the first advertisement 418 to the third ad position 410, and assigns the eleventh advertisement 422 to the fourth ad position 412. The page 402, when displayed on the display screen of the client computing device 102, thus includes the advertisements 418-424 at the above described ad positions 406-412. When the user selects any of the advertisements 418-424 displayed on the page, the advertiser corresponding to the selected advertisement is charged a fee based upon the highest non-winning bid value or the reserve bid value, whichever is higher.

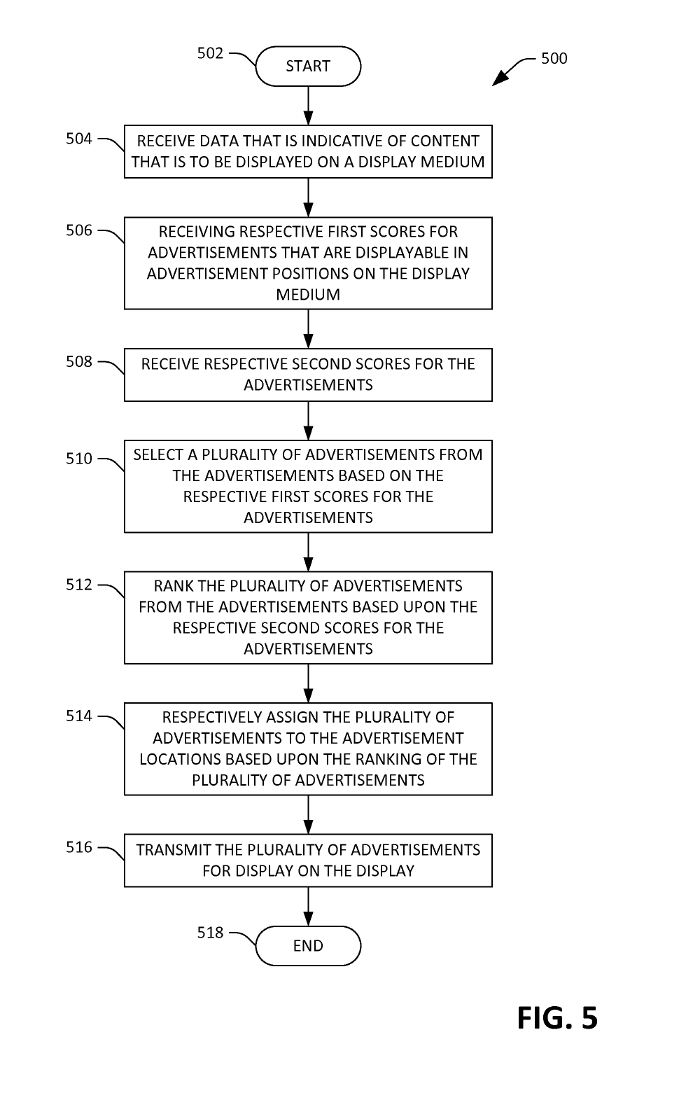

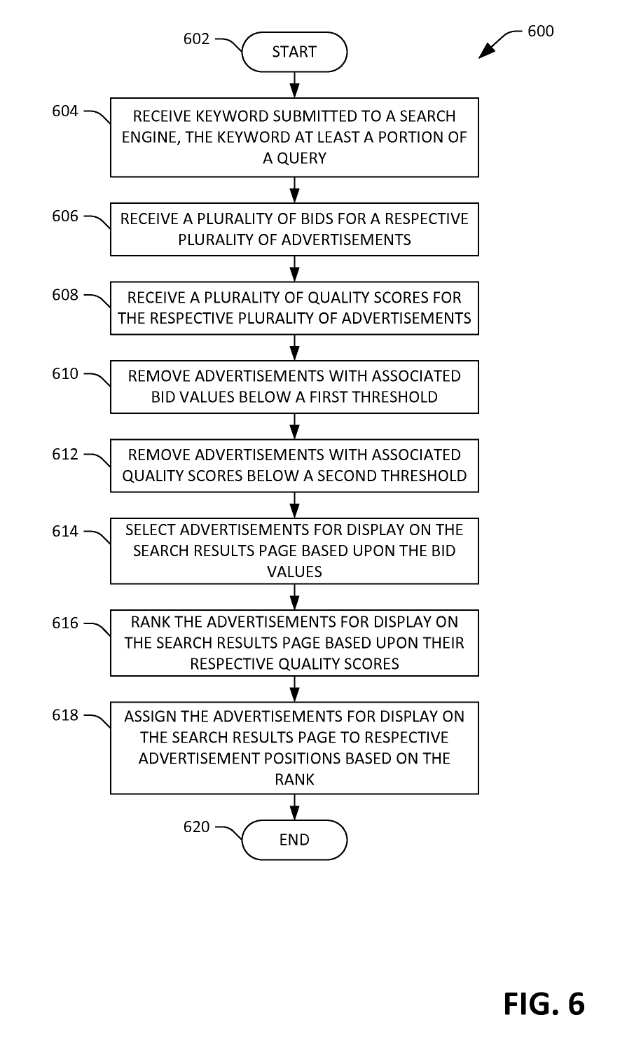

FIGS. 5-6 illustrate exemplary methodologies relating to conducting an auction for advertisement positions on a page that is to be displayed on a display screen of a client computing device. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Now referring to FIG. 5, an exemplary methodology 500 that facilitates executing an auction for a plurality of advertisement positions on a display medium that is to be displayed on a display of a client computing device is illustrated. The methodology 500 starts at 502, and at 504 data that is indicative of content that is to be displayed on a display medium is received, wherein the display medium is to be displayed on a display of a client computing device. As noted above, the received data can be a query (or a portion thereof) set forth to a search engine, a word or phrase in a newsfeed, profile data pertaining to a user, etc. In an example, the received data can be data received from a browser on the client computing device, wherein such data can be in the form of a cookie captured at the browser. At 506, respective first scores for advertisements that are displayable in advertisement positions on the display medium are received, wherein the advertisements have set forth respective indications that they are to participate in an auction for the advertisement positions on the display medium. At 508, respective second scores for the advertisements are received. In an example, the first scores may be independent of the second scores and vice versa. As noted above, the first scores can be bid values for the advertisements and the second scores can be quality scores for the advertisements.

At 510, a plurality of advertisements from the advertisements are selected for display on the display medium based on the respective first scores for the advertisements. For example, a number of advertisements in the plurality of selected advertisements can be equivalent to the number of advertisement positions on the display medium. At 512, subsequent to selecting the plurality of advertisements from the advertisements, the plurality of advertisements are ranked based upon the respective second scores for the plurality of advertisements, wherein the ranking can be performed independent of the first scores. At 514, the plurality of advertisements are respectively assigned to the advertisement positions based upon the ranking of the plurality of advertisements. As noted above, the advertisement ranked highest in the ranking can be assigned to the most desirable advertisement position (e.g., the uppermost or largest advertisement position). At 516, the plurality of advertisements are transmitted for display on the display in the display medium. For example, the plurality of advertisements can be transmitted to a content server, which includes the plurality of advertisements in the display medium. In another example, an application executing on the client can receive the plurality of advertisements directly from an ad server. The methodology 500 completes at 518.

Now referring to FIG. 6, another exemplary methodology 600 that facilitates displaying advertisements at advertisement positions on a page is illustrated. The methodology 600 starts at 602, and at 604 a keyword submitted to a search engine is received, wherein the keyword is at least a portion of a query set forth by a user. At 606, a plurality of bids having a respective plurality of bid values are received for a respective plurality of advertisements. At 608, a plurality of quality scores for the respective plurality of advertisements are received.

At 610, advertisements with associated bid values below a first threshold are removed from consideration (e.g., are prevented from participating in the auction). At 612, advertisements with associated quality scores below a second threshold are removed from consideration. At 614, advertisements are selected for display on the search results page based upon the bid values, wherein a number of advertisements selected is equivalent to a number of advertisement positions on the search results page. At 616, the advertisements are ranked based upon their respective quality scores. More particularly, the advertisements selected for display with the search results are ranked based upon their respective quality scores. At 618, the selected advertisements for display on the search results page are assigned to respective advertisement locations based upon their rank in the ranking The advertisements can then be caused to be included on the search results page at positions corresponding to the assignments. The methodology 600 completes that 620.

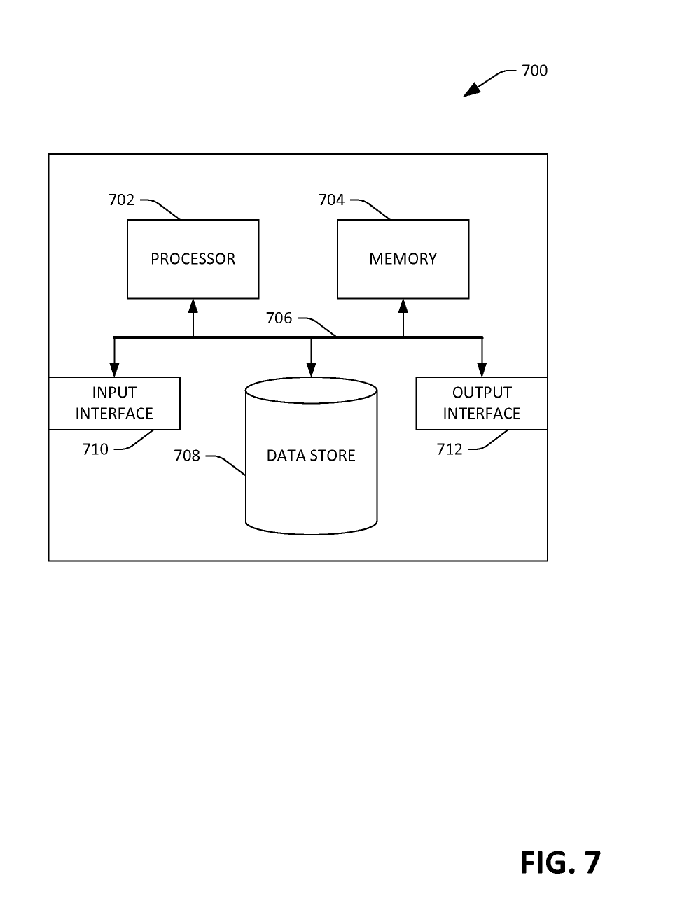

Referring now to FIG. 7, a high-level illustration of an exemplary computing device 700 that can be used in accordance with the systems and methodologies disclosed herein is illustrated. For instance, the computing device 700 may be used in a system that supports conducting an auction for advertisement positions. By way of another example, the computing device 700 can be used in a system that displays a page on a display screen, where the page includes advertisements. The computing device 700 includes at least one processor 702 that executes instructions that are stored in a memory 704. The instructions may be, for instance, instructions for implementing functionality described as being carried out by one or more components discussed above or instructions for implementing one or more of the methods described above. The processor 702 may access the memory 704 by way of a system bus 706. In addition to storing executable instructions, the memory 704 may also store advertisements, bid values, quality scores, etc.

The computing device 700 additionally includes a data store 708 that is accessible by the processor 702 by way of the system bus 706. The data store 708 may include executable instructions, advertisements, bid values, quality scores, etc. The computing device 700 also includes an input interface 710 that allows external devices to communicate with the computing device 700. For instance, the input interface 710 may be used to receive instructions from an external computer device, from a user, etc. The computing device 700 also includes an output interface 712 that interfaces the computing device 700 with one or more external devices. For example, the computing device 700 may display text, images, etc. by way of the output interface 712.

It is contemplated that the external devices that communicate with the computing device 700 via the input interface 710 and the output interface 712 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 700 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 700 may be a distributed system. Thus, for instance, several devices may be in communication by way of a network connection and may collectively perform tasks described as being performed by the computing device 700.

Various functions described herein can be implemented in hardware, software, or any combination thereof If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer- readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method executed by a computing device, the method comprising:
receiving data that is indicative of content that is to be displayed on a display medium, the page to be displayed on a display, the display medium comprising a plurality of advertisement positions for inclusion of respective advertisements;
responsive to receiving the data, executing an auction for the plurality of advertisement positions on the display medium, wherein executing the auction for the plurality of advertisement positions on the display medium comprises:
receiving respective first scores for advertisements that are to participate in the auction;
receiving respective second scores for the advertisements, the respective first scores being different than the respective second scores;
selecting, for display on the display medium, a plurality of advertisements from the advertisements based on the respective first scores for the advertisements;
subsequent to selecting the plurality of advertisements from the advertisements, ranking the plurality of advertisements based upon the respective second scores for the plurality of advertisements; and
respectively assigning the plurality of advertisements to the advertisement positions based upon the ranking of the plurality of advertisements;
transmitting the plurality of advertisements for display on the display in the display medium, wherein the display medium, when displayed on the display screen, comprises the content and the plurality of advertisements in the assigned advertisement locations, wherein a charge to be assessed to an advertiser that owns an advertisement in the plurality of advertisements is based at least in part upon a score of at least one advertisement in the plurality of advertisements or a reserve score.

2. The method of claim 1, wherein the data that is indicative of the content to be displayed on the display medium is a query submitted to a search engine, and wherein the display medium is a search results page that comprises search results returned by the search engine responsive to receipt of the query.

3. The method of claim 1, wherein the first scores are based upon respective bid values corresponding to the advertisements.

4. The method of claim 1, wherein executing the auction further comprises:
prior to selecting the plurality of advertisements from the advertisements, comparing the respective first scores for the advertisements with a first predefined threshold;
determining that a respective first score from the first scores for each advertisement in the plurality of advertisements is above the first predefined threshold; and
selecting the plurality of advertisements based upon the determining that the respective first score for each advertisement in the plurality of advertisements is above the first predefined threshold.

5. The method of claim 4, wherein executing the auction further comprises:
prior to selecting the plurality of advertisements from the advertisements, comparing the respective second scores for the advertisements with a second predefined threshold;
determining that a respective second score from the second scores for each advertisement in the plurality of advertisements is above the second predefined threshold; and
selecting the plurality of advertisements based upon the determining that the respective second score for each advertisement in the plurality of advertisements is above the second predefined threshold.

6. The method of claim 1, the display medium being a web page.

7. The method of claim 1, the display medium being a page of a social networking application, the data that is indicative of the content comprising a post on the page of the social networking application.

8. The method of claim 1, wherein respective first scores of the plurality of advertisements are highest scores from amongst the respective first scores of the advertisements.

9. The method of claim 8, wherein an advertisement from the plurality of advertisements having a highest second score from amongst the respective second scores of the plurality of advertisements is ranked highest in the ranking, and wherein the advertisement is assigned an uppermost advertisement position on the display medium based upon the advertisement being ranked highest in the ranking

10. The method of claim 1, wherein the respective second scores for the advertisements are based upon respective click probabilities of the advertisements when displayed on the display medium.

11. The method of claim 1, further comprising:
receiving an indication that the advertisement in the plurality of advertisements has been selected when displayed on the display medium; and
responsive to receiving the indication that the advertisement has been selected, assessing the charge to the advertiser that owns the advertisement, the charge based upon a highest first score of non-selected advertisements.

12. A computing device, comprising:
a data store that comprises advertisement data for a plurality of advertisements, the advertisement data comprising, for each advertisement in the plurality of advertisements:
a respective first score assigned to an advertisement; and
a respective second score assigned to the advertisement, the respective first score being calculated in a different manner from the respective second score; and
a processor that executes a plurality of components, the plurality of components comprising:
a receiver component that receives an indication that a page is to be displayed on a display, the page comprising a plurality of advertisement positions; and
an auction executor component that is configured to assign a subset of advertisements in the plurality of advertisements to the advertisement positions responsive to the receiver component receiving the indication, a number of advertisements in the subset of advertisement being equal to a number of advertisement positions in the plurality of advertisement positions, the auction executor component comprising:
an ad selector component that selects the subset of advertisements from the plurality of advertisements based upon the respective first score for each advertisement;
an ad ranker component that, responsive to the ad selector component selecting the subset of advertisements, outputs a ranking of the subset of advertisements based upon the respective second score for each advertisement in the subset of advertisements;
an ad assignor component that assigns the subset of advertisements to the advertisement locations based upon the ranking; and
a price setter component that sets prices to be charged to advertisers that own the subset of advertisements based at least in part upon a score of at least one advertisement or a reserve score.

13. The computing device of claim 12, the page being a search results page, the indication being receipt of a keyword provided to a search engine application that generates the search results page.

14. The computing device of claim 12, the page comprising a news feed of a social networking application, the indication received form the social networking application.

15. The computing device of claim 12, the page being a web page, the indication comprising a cookie captured by a web browser.

16. The computing device of claim 12, the auction executor component further comprises an ad filter component that prevents an advertisement in the plurality of advertisements from being included in the subset of advertisements based upon either 1) the respective first score assigned to the advertisement being below the reserve score; or 2) the respective second score assigned to the advertisement being below the reserve score.

17. The computing device of claim 12, wherein the respective first score is a respective bid value submitted by the advertisement.

18. The computing device of claim 17, wherein the respective second score is indicative of a probability that a viewer of the page will interact with the advertisement.

19. The computing device of claim 12, wherein the respective first score and the respective second score are independent from one another.

20. A computer-readable storage medium comprising instructions that, when executed by a processor, cause the processor to perform acts comprising:
receiving a keyword submitted to a search engine, the search engine configured to generate a search results page for display on a client computing device based upon the keyword, the search results page comprising a plurality of advertisement positions;
responsive to receiving the keyword, executing an auction for the plurality of advertisement positions, wherein executing the auction comprises:
receiving a plurality of bids for a respective plurality of advertisements, the bids having respective bid values;
receiving a plurality of quality scores for the respective plurality of advertisements, the quality scores based upon respective probabilities that the respective advertisements will be selected when included in the search results page;
selecting a subset of advertisements from the plurality of advertisements based upon respective bid values for the subset of advertisements, a number of advertisements in the subset of advertisements being equal to a number of advertisement positions in the plurality of advertisement positions;
ranking the subset of advertisements based upon respective quality scores for the subset of advertisements, the ranking performed without regard to the respective bid values for the subset of advertisements; and
assigning advertisements in the subset of advertisements to respective advertisement positions in the plurality of advertisement positions based upon the ranking of the subset of advertisements, wherein the search results page, when displayed on the client computing device, comprises the advertisements in the subset of advertisements in the respective advertisement positions, and wherein prices are set for the advertisements in the subset of advertisements based upon the bids or a reserve score.
